(19) United States
(12) Patent Application Publication
(10) Pub. No.: US 2003/0129292 A1
(43) Pub. Date: Jul. 10, 2003

(54) Tomato paste and sauce and process for preparation

(75) Inventors: Nancy Blaker, Sacramento, CA (US); Jinguo Hu, Fargo, ND (US); Adel El-Sheikh, Woodbridge, CA (US); Anthony John Barraclough, Wellingborough (GB); Jacqueline De Silva, High Street (GB); Michael John Gidley, Raunds (GB); John Turner Mitchell, Bedford (GB)

Correspondence Address: UNILEVER, PATENT DEPARTMENT, 45 RIVER ROAD, EDGEWATER, NJ, 07020, US

(73) Assignee: Lipton

(21) Appl. No.: 10/214,208

(22) Filed: Aug. 6, 2002

Related U.S. Application Data
(63) Continuation-in-part of application No. 09/053,717, filed on Apr. 2, 1998, now abandoned.

(51) Int. Cl. A23L 1/238

(52) U.S. Cl. 426/589

(57) ABSTRACT

Homozygous rin and/or nor and/or alc tomatoes, or tomatoes heterozygous in both rin and nor and/or alc are used to prepare a tomato paste, juice or sauce having good viscosity as well as good color. Preferably the tomatoes used also include color enhancing genes such as old gold crimson (og^{c}) high pigment (hp), dark green (dg), intense pigment (Ip), or color enhancing transgenic genes.

This is a continuation-in-part of Ser. No. 09/053,717, filed Apr. 4, 1998.

### FIELD OF THE INVENTION

The present invention relates to processed tomato products and a process for preparing tomato products.

### BACKGROUND OF THE INVENTION

In the industry of processing tomatoes to end products like sauces, ketchups, soups, toppings, etc. usually two stages are distinguished: primary processing and secondary processing. Primary processing usually involves at least either hot- or cold breaking of the tomatoes and a concentration step. In the concentration step water is removed from the tomato pulp, so as to obtain a thick paste. The water removal can be done by many ways, although evaporative removal of water (by heating) is the common method. The so-obtained thickened paste or puree can be stored or directly further processed into a range of finished products such as tomato sauce for pasta, tomato ketchup, etc.

Such end products generally need a specific thickness to be valued as quality products (next to a good color, flavor, etc.). In order to achieve this, it is preferred that the product has (at a given percentage of soluble solids) a high consistency. Consistency in the tomato industry is often measured and expressed as Bostwick value. In the handbook “Tomato Production, Processing & Technology” (3^{rd} ed.) by W. A. Gould, CTI Publications, Timonium, Md., USA it is set out on page 329, 330 how Bostwick measurements on tomato purees and pastes are usually performed in the tomato processing industry and tomato research.

In part, the thickness is determined by the amount of insoluble solids present per unit of tomato product. The insoluble solids are in part cellulose, pectins and other compounds that make up the structural matrix of the fruit. The amount of insolubles may vary per variety, season, growth stage, etc. The degree of concentration of tomato products is usually expressed in degrees Brix and is an indication of the amount of soluble solids in a tomato(product). To exemplify this: a tomato paste of 20 Brix is considered to be twice as much concentrated as a paste of 10 Brix of the same tomatoes.

Of course, in order to achieve thick products one can highly concentrate the tomato puree. The result will be a product with a high degree of Brix, a firm consistency (expressed by low Bostwick value). However, this is costly, as many kilograms of tomatoes are needed to produce one kilogram of tomato product, and the evaporative concentration is also a cost factor. Furthermore, flavor and color can be adversely affected by rigorous concentration, e.g. due to burning in the evaporators.

Many techniques have been developed to thicken paste without changing Brix value. Such methods include treating of the pectic substances with enzymes, adding thickeners, etc. These methods all have their disadvantages.

Hence, there is a need for tomato paste having a firm consistency at a reasonable Brix value. Also, there is a need for processed tomato products other than tomato paste (in the strict sense of the word) which have an increased consistency.

Tomatoes which yield juice having high viscosity are valued in production of tomato sauces. Unfortunately, tomatoes used commercially in recent years have tended to yield juices having less than optimal viscosity. In general, as ripening of tomatoes progresses, the viscosity of resulting juices decreases. The ripening inhibitor gene (rin) is a semi-dominant gene which was first described in 1968 by Robinson and Tomes. “Ripening Inhibitor: A Gene with Multiple Effects on Ripening.” Rpt. Tomato Genetics Cooperative 18:36-37. Tissue softening and pigment synthesis which occur in normal tomato fruits are inhibited in fruits of rin tomato mutants.

Heterozygous rin tomato fruit ripen more slowly than normal fruit, are firmer and have less polygalacturonase (PG) activity than non-rin fruit. Carotenoid accumulation is delayed and somewhat reduced in the heterozygous rin fruit, as reported by Buescher et al. 1976. “Softening Sci. 11:603-604. See also Murray et al. 1995, “Evaluation of transgenic tomato fruit with reduced polyglacturonase activity in combination with the rin mutation.” Postharves Biology and Technol. 6:91-101.

Tomatoes having the rin gene in the heterozygous condition have been sold as fresh tomatoes and used as processing tomatoes. However, while heterozygous rin tomatoes are firmer, the viscosity of the juice prepared from heterozygous rin tomatoes is still less than optimal; although use of rin heterozygotes can result in small increases in serum viscosity and lower Bostwick thickness values in cold break processing, heterozygous rin fruit do not differ from non-rin tomatoes in Bostwick thickness or serum viscosity when processed by hot break methods.

Davies et al., 1981, “The Constituents of Tomato Fruit—The Influence of Environment, Nutrition and Gene Type,” CRC Critical Reviews in Food Science and Nutrition, 15:205-280, indicates that the deleterious effects of ripening inhibitor genes in the heterozygous state may possibly be overcome by incorporating genes which will enhance color, such as high pigment and crimson.

Old gold crimson, a color enhancing gene, was first described in 1962 (Butler, L/R. and Tomes, M. L., 1962, “Crimson, a new fruit color,” Tomato Genet. Coop. Rpt. 12:17-18) and was determined by Thompson et al. (“Characterization of crimson tomato fruit color,” 1965, Proc. Amer. Soc. Hort. Sci. 86:610-616) to be a single recessive gene.

Fruits homozygous for rin are known, but it is also known that the normal ripening processes such as chlorophyll degradation, carotenoid biosyntheses, increased respiration, increased ethylene production and PG activity are nearly inhibited, Tigchelaar et al. 1978, “Genetic Regulation of Tomato Fruit Ripening,” Hort. Sci 13:508-513; Della Penna et al. 1987, “Polygalacturonase Gene Expression in Rutger, rin, nor NR., Tomato Fruits,” Plant Physiol, 85:502-507.” According to Tigchelaar et al. the color of mutant rin is generally unacceptable for traditional fresh or processed use (p. 512). And Buescher et al. state that since no method has been discovered which will adequately ripen rin or nor tomatoes, the mutants are presently only suitable for processed green tomato products.

Fruits heterozygous in both rin and in nor are known, e.g. from Kopelovitch et al., “The Potential of Ripening Mutants for Extending the Storage Life of the Tomato Fruit,” Euphytica 28 (1979), 99-104. They disclose that in plants heterozygous for rin and nor, softening of fruit and carotenogensis proceed at a rate intermediate between the normal and the mutant parents.

Kopelovitch et al. produced various homozygotes and F1 heterozygotes and reported that none of the homozygous ripening mutants developed normal or even pale-red pigmentation whereas in all heterozygotes between ripening mutants and high-pigment, a red, pale red or pink color had developed when the fruits were picked ripe. Fruit of the F1 hybrid between rin and nor developed a pale red color said to be acceptable for marketing. Fruit homozygous for rin or nor showed extremely long shelf life and the F1 (rin×not) also exhibited excellent keeping ability. Among F1 crosses with hp, the most promising was said to be the one with nor.

Tigechelaar et al., “Natural and Ethephon-Stimulated Ripening of F1 Hybrids of the Ripening inhibitor (rin) and Non-ripening (nor) Mutants of Tomato (Lycopersicon esculentum Mill.) Aust. J. Plant Physiol., 1978, 5, 449-456 discloses ripening experiments with rin and nor hybrids.

Nahum, U.S. Pat. No. 4,843,186 discloses a heterozygous tomato plant, heterozygous in rin, which is said to develop a full red color.

It is believed that tomatoes homozygous in rin and including one or more color enhancing genes are used commercially, but only to make heterozygous rin tomatoes, rather than for making paste.

### SUMMARY OF THE INVENTION

In a first aspect of the invention, it has now been found that the above needs may be achieved (at least in part) by a tomato paste having an increased consistency such that when measured at an insoluble solids interval of 2.5-3.6% at 12°Brix:

(Bostwick value)<10.5−2.3822×(percentage of insoluble solids), (1)

when Bostwick is measured as defined in the Gould reference given above.

Preferably, this is achieved by a tomato paste having an increased consistency such that when measured at an insoluble solids interval of 2.5-3.6% at 12°Brix:

(Bostwick value)<10.0−2.3822×(percentage of insoluble solids). (2)

Most preferably, this is achieved by a tomato paste having an increased consistency such that when measured at an insoluble solids interval of 2.5-3.6% at 12°Brix:

(Bostwick value)<9.5−2.3822×(percentage of insoluble solids). (3)

As is stated above, the tomato paste when measured should have an insoluble solids level of 2.5-3.6%, and at 12°Brix. Pastes with different levels of Brix are also part of the invention, but need to be concentrated/diluted before measurement. In the above, the Bostwick value will suitably be above 0.1 at said Brix level.

Tomato paste is herein to be understood as a commercially-processed (or factory-processed) tomato paste as it is known in the art of tomato processing. Such tomato paste is the result of primary processing tomatoes (comminution/heating and concentrating by removal of water) as is done shortly after harvesting. A hot break process is preferred for optimal consistency. The resulting product is a concentrated paste, which can be stored until further use, or can be sold. There are commercial producers of such tomato paste (product). For comparison and measuring, such paste should be free of added thickeners, such as starches or gums. Also, for comparison and measuring, the pastes should not have been subjected to additional processing steps that may increase the consistency, such as homogenization treatment. Conventional, commercially available paste is free of such additional thickeners or process steps.

Although for measuring the Bostwick value at 12°Brix as set out above the tomato paste is a paste obtained with a hot break process, without additional process steps or ingredients that influence the consistency, the invention may be applied to all sorts of tomato paste (hot and cold), which do comprise additional thickeners or process steps that influence the consistency.

For a commercially available paste one can measure Bostwick, Brix, and insoluble solids, and such numbers can give an indication of the quality of the paste.

Tomato paste can be obtained by a hot break process (comminuting and heating to approx. 80° C.), optionally followed by a concentration step to bring it to the required Brix value. Such concentration (i.e. water-removal) will usually be done by evaporation. The tomato paste according to the invention does not contain gums, starches, or other thickeners when measuring Bostwick and Brix value. Bostwick is usually measured at 12°Brix. If the tomato paste has a too high Brix value, dilution with water to the required value of 12° may be applied.

The tomato paste according to the invention preferably is red, as expressed by having a USDA color score at 8.5°Brix of 35-60. Dilution may be needed to measure at the required Brix value.

There are factories (“secondary processing”) that buy/use tomato paste for preparing processed tomato products, such as pasta sauce, juice, ketchup, etc. Such processed tomato products may also be prepared from tomato paste, or from fresh tomatoes. Following this, apart from a tomato paste with an increased consistency, there is also a desire for processed tomato products with a good consistency.

As indicated above, one factor which limits the consistency that can be obtained from processed tomato products is the softening of fruit that takes place as part of the ripening process. Aspects of fruit ripening such as development of color and flavor give rise to desirable characteristics in processed tomato products. It would be advantageous to combine the high consistency of unripe fruit with the color and/or flavor of ripe fruit in a processed tomato product.

A number of genes are involved in controlling the process of tomato fruit ripening. Mutations in such genes can lead to ripening-inhibited fruit in which all aspects of the ripening process, such as softening, red color formation, and flavor development are inhibited. If the mutation is present in homozygous form, softening is minimized, and development of both color and flavor is severely restricted. Examples of gene mutations that result in ripening-inhibition in tomatoes, some of which are mentioned above, include ‘alcobaca’ (alc), ‘ripening-inhibited’ (rin), ‘non-ripening’ (nor), and ‘Never ripe’ (Nr).

In accordance with the invention, it is believed that both tomato paste and processed tomato products with a good consistency can suitably be achieved if tomatoes homozygous in alc, rin, nor, or Nr are used to prepare a tomato paste or processed tomato product. Hence, the invention further pertains to a paste or product comprising tomatoes which are homozygous for alc, homozygous for rin, homozygous for nor, homozygous for Nr, heterozygous for combinations of (at least) two of the alc, rin, nor or Nr genes, or combinations thereof. Such tomatoes are herein after referred to as “tomatoes according to the invention.”

In a preferred aspect of the invention, the paste or product is prepared by using tomatoes according to the invention and which in addition comprise color enhancing genes such as old gold crimson (ogc), high pigment (hp), dark green (dg), intense pigment (Ip), or color enhancing transgenic genes. Such tomatoes can not only be used to make tomato paste but can be used for a whole range of processed tomato products. The term “processed tomato product” is herein to be understood as to comprise any product that comprises tomatoes which are subjected to processing steps (in any order) such as heating and breaking and optionally concentrating and packing. Examples of processed tomato products are: tomato pastes, tomato sauces, tomato juices, tomato concentrates, tomato passatas, salsa, barbecue sauce, pizza sauce, spaghetti sauce, tomato fritto, ketchup (catsup), soup or other form.

As a result of the invention, it is possible to take advantage of the outstanding paste and serum viscosity of tomatoes which are homozygous for the ripening inhibitor, e.g., alc, genes without sacrificing desirable tomato color characteristics which are of importance to consumers. Also, the paste and serum of the tomatoes enjoy excellent resistance to syneresis. It is likewise believed that homozygous rin tomatoes, homozygous nor tomatoes, homozygous Nr tomatoes, or heterozygous alc/rin, alc/nor, alc/Nr, rin/nor, Nr/nor, rin/Nr tomatoes can be advantageously used in the present invention.

The tomato paste according to the invention preferably has at 12° Brix Bostwick thickness values in the range of from 0-3 cm, preferably from 0-2 cm. Likewise preferred tomato pastes according to the invention enjoy at 12° Brix syneresis levels of less than 4 mm, preferably less than 3 mm. This is in contrast to Bostwick values of 4.5-7 cm and syneresis values of 13-25 mm for, e.g., the BOS 3155 variety (an industry-known variety).

The invention may provide tomato pastes and other processed tomato products having both good color and outstanding thickness, without requiring the mixing of different types of tomatoes. Preferably USDA paste color scores at 8.5° Brix for pastes of the invention are at least 35, especially greater than 42. Preferably, said color scores are below 60 or below 50. USDA scores are standardized measurements for color quality.

We have found that it is possible advantageously to utilize a tomato having both homozygous ripening inhibiting genes such as alc, and the old gold crimson (ogc) genes, wherein the tomato color is good, yet at the same time tomato fruit firmness and juice and paste viscosity are excellent as a result of the ripening inhibiting effect of the ripening inhibiting, e.g. alc gene.

Following the above, the present invention relates to processed tomato products such as tomato pastes, tomato sauces, tomato juices, tomato concentrates, tomato passatas, salsa, barbecue sauce, pizza sauce, spaghetti sauce, tomato fritto, ketchup (catsup), soup and others, which processed tomato products comprise tomatoes according to the invention. Preferably, the above products are prepared from tomatoes which further include color enhancing genes as well. Processed tomato products preferably have a Brix value of 5-31°, preferably (depending upon the intended use) of 10-25°. Also depending upon the use, they may contain 0.1-5% wt, preferably 0.5-3% wt of salt, most preferably 1-2% wt. The pH may suitably be between 3 and 5, preferably between 4.0 and 4.4.

Preferably, the invention concerns processed tomato products made from populations or assemblages of the above fruits having an average of at least 10% by weight, and preferably at least 25%, more preferably at least 50% of the tomatoes with the above-described genes. The tomatoes for such processed tomato products may be obtained through classical breeding and selecting, but may also be obtained by genetic modification, as is set out in WO 01/04315 and WO 01/14561.

The pastes of the invention preferably include at least 50% by weight of the tomatoes according to the invention, especially from 50 to 100% by weight. Juices preferably include at least 10% by weight of the tomatoes according to the invention, especially from 20 to 40% by weight.

Preferably, the tomatoes according to the invention are homozygous for the color enhancing gene such as ogc.

Use of the tomatoes according to the invention is particularly beneficial in view of their unique qualities, such as extremely high viscosity and almost no syneresis. It is believed these advantages are not achieved with tomatoes or tomato pastes outside of our invention (when measured with equivalent soluble solids level and in the absence of other thickening material, such as starch, gums, etc.). A secondary benefit is that as a result of such characteristics, less paste can be used in preparing a sauce. The advantageous paste characteristics according to the invention can be expected to translate to improved, consumer perceivable characteristics for processed tomato products, such as improved mouthfeel and texture and to lead to more full-bodied sauces and other products.

The present invention is directed then, in part, to the discovery that, contrary to expectations, homozygous ripening inhibiting tomatoes can be successfully used to prepare an acceptable paste or a sauce, e.g., a red pasta sauce.

In one aspect, then, the invention pertains to a paste comprising tomatoes which are homozygous in ripening inhibiting genes or heterozygous in two ripening inhibiting genes. Pastes may include tomatoes which are homozygous in rin and/or nor and/or alc. In a still more preferred additional aspect of the invention, the paste is prepared by using tomatoes which are homozygous in the rin and/or nor and/or alc genes or heterozygous in both rin and/or nor and/or alc and which in addition comprise color enhancing genes such as old gold crimson (og), high pigment (hp), dark green (dg), intense pigment (Ip), as well as color enhancing transgenic genes.

In addition to pastes, the invention pertains to juices and sauces made for homozygous ripening inhibiting tomatoes such as rin and/or nor and/or alc tomatoes or from tomatoes heterozygous in rin and/or nor and/or alc, and, preferably to pastes, juices and sauces made from tomatoes which are homozygous in rin and/or nor and/or alc, or heterozygous in rin and/or nor and/or alc, and which include color enhancing genes, as well.

Although it is believed tomatoes as such are known which are homozygous in rin or one or more other ripening-inhibiting genes mentioned, it is believed such tomatoes have never been used in tomato processing. Also, the tomatoes homozygous in rin that have been studied usually referred to tomatoes that do not form color. Hence, (industrially) processed tomato products (and tomato paste) having the properties as described above are novel, and in particular such processed tomato products that have a red or reddish color (e.g. USDA color score of at least 35, optionally less than 60). Furthermore, it is quite surprising that processed tomato products of good quality in terms of consistency and color could be achieved having the properties as now claimed, as tomatoes that are firm are usually associated with green, unripe tomatoes. Unripe, green tomatoes are unsuitable to use in large quantities in conventional tomato products, following the color and the flavor profile which is different from ripe tomatoes.

Without wishing to be bound by theory, it is believed that tomatoes according to the invention are different from conventional tomatoes in that such genes may occur in conventional tomatoes, but not in a homozygous genotype. When such genes are present in homozygous form, they may interrupt part of the ripening process. It is believed (but this is speculation) that the tomatoes according to the invention have different cell walls, e.g. more dense cell walls.

It has been found that a tomato believed to be homozygous in alc has levels of certain enzymes which are different from conventional tomatoes. It was found that such a tomato, also comprising a color gene such as ogc, had similar levels of exogalactanase when green as a conventional tomato. This is not surprising, but several days post breaker (i.e. when pinkish/orange/red) the level of exogalactanase stayed low for the alc/ogc tomato, whereas for conventional tomato this level increases substantially. Regarding polygalacturonase similar findings were obtained. Processing such tomatoes into processed tomato products has distinct advantages. Still, thanks to the color gene ogc, such tomato has good color. Although a process may involve processing only such tomatoes, it may be preferred to use a blend of tomatoes: conventional tomatoes (for economic reasons) with tomatoes according to the invention. Preferably, such tomatoes according to the invention should also have one or more of the color genes as set out hereinbefore.

Hence, the present invention also relates to a process for preparing a tomato product, the product having a USDA color score of 35-60 and wherein at least 10% (pref. at least 20%, more pref. at least 50%, up to 100%) of the tomatoes to be processed have a level of polygalacturonase of less than 200 (preferably less than 100, more pref. less than 50, usually more than 1) μmoles GalA/ml/hour, and wherein said tomatoes to be processed have a level of exogalactanase of less than 70 (preferably less than 50, most preferably less than 35, usually more than 0.1) nmoles galactose/g fwt/hour (fwt=fresh weight). In this, it is preferred that at least 10% (pref. 20%, more pref. 50%) of the tomatoes to be processed are homozygous for rin, homozygous for nor, homozygous for Nr, homozygous for alc, heterozygous for combinations of two of the rin, nor, Nr or alc genes, or combinations thereof. It may also be preferred that the tomatoes are homozygous for at least two of rin, nor, Nr, or alc.

As (depending on amount used, and desired end product) it may be preferred that the resulting product has some color, it is preferred that the tomatoes as used in the process as set out above further comprise at least one color enhancing gene. For example, said color enhancing genes may be selected from the group consisting of old gold crimson (ogc), high pigment (hp), dark green (dg), intense pigment (Ip), as well as color enhancing transgenic genes.

Conventional tomatoes are usually processed into paste using either a cold-break process or a hot-break process. The hot-break process involves heating to above about 80° C. and comminuting (‘breaking’) the tomatoes, whereas a cold break would be heating to below about 80° C. and comminuting (‘breaking’) the tomatoes. The hot break process has as advantage that endogenous enzymes are inactivated quickly, including pectin-degrading enzymes like exogalactanase and polygalacturonase. Such a product (e.g. paste) with substantial amount of long pectin-chains may have good consistency. The disadvantages are that heating may involve damage to the flavor: a cooked or burnt aroma may develop, loosing volatiles and/or fruity flavors. The cold-break process does not de-activate the pectin-degrading enzymes quickly, so some degradation of pectin may occur, resulting in a paste with less consistency. On the other hand, the flavor is usually better for a cold break product. For these reasons, mixtures of cold- and hot break products may be used.

Following the low level of pectin-degrading enzymes (polygalacturonase and exogalactanase) of the tomatoes according to the invention, such tomatoes may be processed using a so-called ‘cold break process’ and have consistency more similar to hot break products, as it is believed by nature less pectin-degrading enzymes are present in the tomatoes according to the invention, and hence even if they are processed into paste using a cold-break process such tomato paste may contain a substantial amount of pectin. Thus, the invention also relates to a process comprising the steps of:

heating tomatoes to a temperature of 60-120° C. (preferably 60-80° C.), size reduction (e.g. comminution or dicing) of said tomatoes in any given order (optionally followed by concentration, e.g., water removed, e.g., by evaporation).

The tomato pastes and processed tomato products may be prepared using conventional processing techniques.

As the tomatoes according to the invention are low in certain enzymes, the invention further relates to a process for preparing a tomato product (e.g. paste or any other product) in which tomatoes are used which are low in polygalacturonase and/or exogalactanase.

The invention also relates to a process and product (i.e. tomato paste and processed tomato product) in which other ripening-inhibiting genes than alc, rin, nor, Nr, are present in the tomato in such a genotypic form that they inhibit ripening similar to the tomatoes as are herein disclosed. This may relate to genes not yet known to inhibit ripening, alone or in combination.

For a more complete understanding of the above and other features and advantages of the invention, reference should be made to the following detailed description of the preferred embodiments and to the accompanying drawings.

### BRIEF DESCRIPTION OF THE DRAWINGS

FIG. 1 is a graph of total solids vs. °Brix for the RIN (rinrin) tomato paste according to the invention and for tomato paste made from commercially available BOS 3155 tomatoes.

FIG. 2 is a graph of concentration dependencies of G′ for the RIN (rinrin) tomato paste according to the invention and for tomato paste made from commercially available BOS 3155 tomatoes.

FIG. 3 is a graph comparing °Brix with G′ for the RIN (rinrin) tomato paste according to the invention and for tomato paste made from commercially available BOS 3155 tomatoes.

FIG. 4 is a graph showing qualitatively the differences in amounts of pectic oligomers for RIN (rinrin) and Bos 3155 paste serums.

FIG. 5 is a graph of Bostwick vs. insoluble solids.

FIG. 6 show exogalactanase levels in several tomatoes.

FIG. 7 is a graph showing PG activity in several tomatoes.

### DETAILED DESCRIPTION OF THE INVENTION

The rin gene, which is semidominate in tomato, is available from several sources, including the C. M. Rick Tomato Genetic Resource Center (TGRC) at the University of California, Davis. The rin gene is described in the literature, e.g., in Davies et al. and Tigchelaar et al., mentioned above.

Another mutant gene directed to impeding ripening is the “non-ripening” nor gene, which is recessive but has ripening and enzymatic characteristics which are very nearly identical to rin. (Buescher et al. 1976, Della Penna et al. 1987, Tigchelaar et al. 1978.) The paste characteristics of the homozygous nor gene can be expected to be nearly identical to those of the homozygous rin paste. Since the homozygous nor fruit suffers from the same color deficiencies as the homozygous rin, this gene likewise can be used in combination with a color enhancing gene in accordance with the invention.

The old gold crimson (og^{c}) color enhancing gene is readily available from several sources including the TGRC at UC, Davis, and is currently used in the tomato processing industry. This color variant was first described in 1962 (Butler and Tomes 1962) and was determined by Thompson et al. (1965) to be a single recessive gene. Fruit containing ocf has a redder color and higher lycopene content than normal fruit. Other color enhancing genes, e.g., those mentioned above, are available and may be used in the present invention.

Whereas the color scores of homozygous rin pastes can be expected to be very low, e.g. USDA paste color scores at 8.5 Brix of <30, the pastes of the invention have good USDA paste color scores at 8.5 Brix, e.g. from 35-60, especially 35-50.

The homozygous ripening inhibiting gene, e.g., rin, plants may be made by at least two methods. The first utilizes a traditional breeding program. Of the several standard breeding methods, the backcross method is the most direct. A tomato line carrying the rin gene, such as LA3012, can be obtained from the C. M. Rick Tomato Genetics Resource Center at UC Davis or from another source and crossed with a commercially desirable cultivar such as FM6203, which can be obtained from Lockhart Seed Co. of Stockton, Calif. or numerous other seed dealers. Other appropriate open pollinated varieties would include Hunt 100 and UC82b. Multiple backcrosses to the recurrent parent (the commercial line) and selection of the rin phenotype would be conducted to recover the commercial cultivar with the rin gene. After the final backcross (BC6), the tomato line would be selfed and the homozygous rin selected. Likewise, the preferred rinrin tomatoes homozygous for color enhancing genes can be prepared by breeding with FM6203.

Alternatively, the rinrin tomato can be obtained via plant transformation. In this method, the rin gene is cloned from a rin tomato line such as LA3012 and introduced into a desirable cultivar using transformation via tissue culture. Methods for transferring foreign DNA into plant cells include use of Agrobacterium tumefaciens as a vector, direct DNA uptake, e.g. facilitated by polyethylene glycol or electroporation, and microinjection of DNA into cells with a particle gun. Fertile plants are regenerated from the culture and these plants transmit the transferred gene to the next generation. If the transferred gene controls a recessive trait, selfing is necessary to make the gene homozygous, displaying the expected trait.

Plants heterozygous in both rin and nor can be obtained by crossing plants heterozygous in rin with plants heterozygous in nor.

The tomato homozygous in the rin gene and heterozygous or homozygous in the color enhancing gene can be obtained by using the transformed rinrin tomato as a starting point and either breeding or transforming the plant to include the color enhancing gene(s). Similarly, if desired, the rinrin tomato may be formed by breeding and the color enhancing gene introduced therein by transformation.

Although the use of homozygous color enhancing genes of the same type are preferred, it is also possible that tomatoes heterozygous in more than one type of color enhancing gene can be used.

The use of homozygous rin and/or nor and/or alc genes is preferred. However, it is also possible that a tomato heterozygous in both the rin and/or the nor and/or alc genes or homozygous in one of the rin or nor or alc genes and heterozygous in the other may be used.

In accordance with the invention, various types of foods products can be prepared from the homozygous ripening inhibiting rin and/or nor tomatoes or heterozygous rin/nor/alc tomatoes. For instance, red spaghetti sauce can be prepared. In general, red sauces, such as spaghetti sauces, will often satisfy the following parameters:

12 to 25 Brix

4-13 cm Bostwick

1-2% salt

pH 4.0 to 4.4

As a result of the unique qualities of the tomatoes and paste mentioned above, a sauce having outstanding quality can be prepared in accordance with the invention.

Among the types of sauces which can advantageously be prepared in accordance with the invention include, but are not limited to, red spaghetti sauce, other red pasta sauces, pesto sauce, salsa, tomato puree, pizza sauce, tomato sauce, BBQ sauce, catsup and soup.

### EXAMPLE 1

### Prophetic

A tomato plant which is homozygous for the rin mutant is produced by the backcross method. Open pollinated variety FM6203 is crossed with LA 3012. FM6203 is emasculated and pollen from LA3012 is applied to the stigma of FM6203. (Alternatively, crosses could be performed using FM6203 as the pollen parent.) The resulting F1 is then crossed again with FM6203. The BC1 progeny which contain rin are determined by selfing the BC1 and examining the BC1F1 for the homozygous rin phenotype.

Alternatively rin carriers can be ascertained by observing the fruit of the BC1 for the heterozygous rin traits such as delayed ripening and increased firmness. Repeated backcrossing to FM6203 and selection for the rin phenotype results in the rin character becoming fixed in the resulting cultivar.

### EXAMPLE 2

### Prophetic

An advanced processing tomato line homozygous for rin and also homozygous for the color enhancing gene old gold crimson is grown under typical field conditions in 50 ft. plots in California. Although fruit are delayed in ripening, ripe fruit are extremely firm with yellow external and red internal color. Approximately 100 pounds of fruit are harvested and processed using a bench scale hot break and tubular evaporator system (manufactured by Femco Co.). The rinrin tomato paste is concentrated to only 15.5 °Brix due to the extreme viscosity of the puree. In contrast, paste of typical tomato cultivars is concentrated to 21-26° Brix using this equipment.

The data from the analysis of rinrin paste is given below. The paste attributes of the rinrin paste are compared with paste from a commercial tomato cultivar, (Bos 3155 which can be obtained from Lockhart Seed Co. of Stockton, Calif. or numerous other seed dealers) processed in the same manner and using the same equipment as the rinrin paste.

Comparison of Rinrin and Bos 3155 Tomato Pastes

Summary and Conclusions

1. rinrin paste is thicker than the Bos 3155 paste because of a combination of a more expanded particulate phase and a higher serum viscosity.

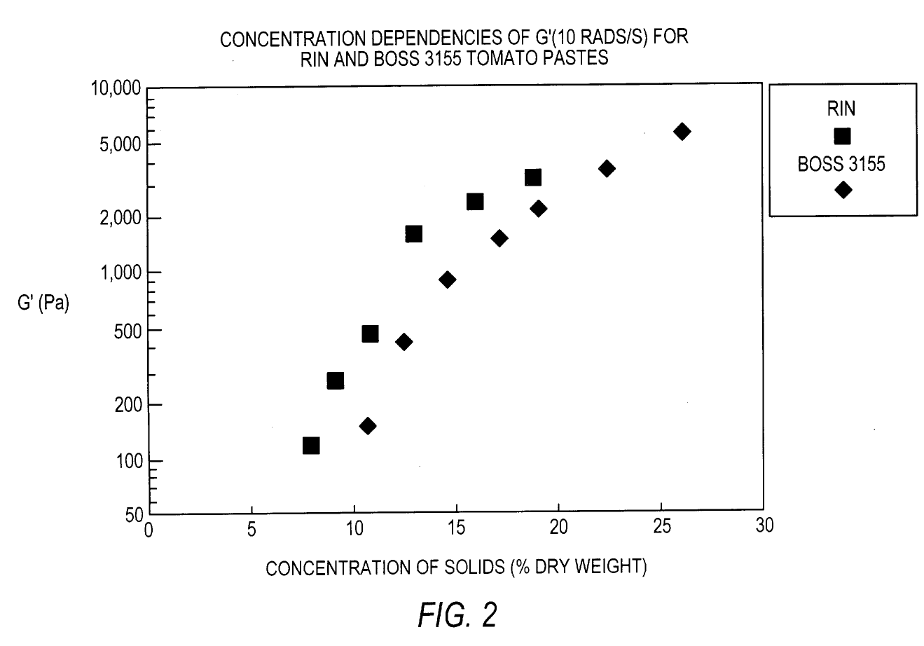

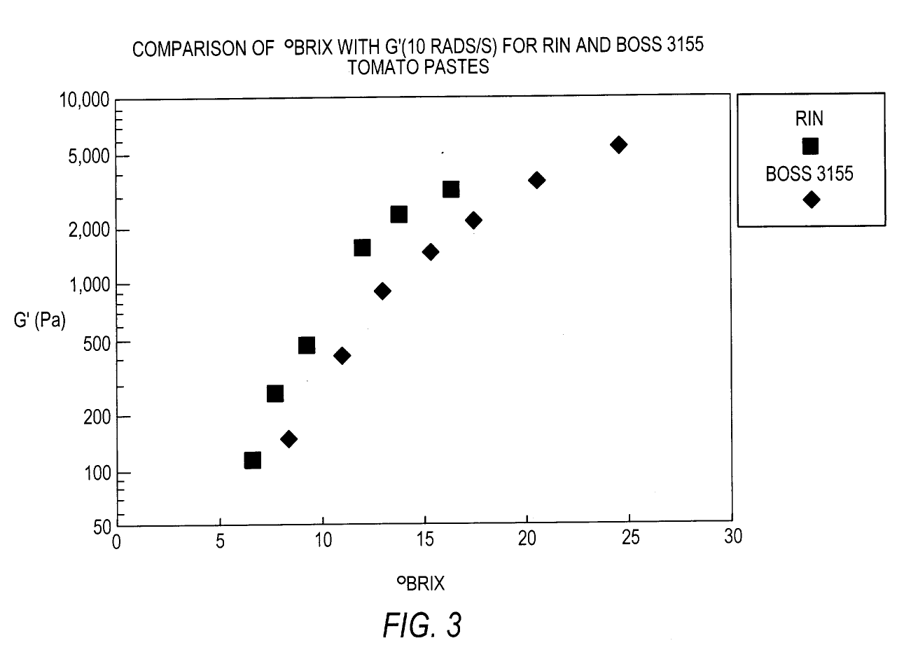

2. The more expanded particulate phase is deduced from the lower serum/pellet ratio of the rinrin, and is consistent with a lower concentration onset for significant thickening (FIGS. 2 and 3).

3. The viscosity of the serum phase of rinrin is very high (not only compared with Bos, which is relatively low, but also other pastes). This is probably the origin for the low blotter scores for rin and the high blotter scores for Bos 3155.

4. Two lines of evidence suggest that the Bos paste suffers more enzymatic damage to pectins than the rinrin. The 5% esterification of pectic galacturonic acid is high in rin and relatively low in Bos 3155. This suggests that PME (pectin methylesterase) is not acting significantly on rin but has on Bos 3155. Secondly pectic oligosaccharides are more abundant in Bos than in rin, consistent with the significant action of PG on the former but not the latter. The fruit is not analyzed, so it is not known how much of these changes are caused in the fruit, and how much is due to response to process.

Methods and Definitions

Brix measurements—These values reflect the content of soluble sugars in the serum fraction of paste by determination of refractive index. The measurements are made using a Bellingham and Stanley Ltd RFM 320 Refractometer, calibrated against distilled water. A sample of tomato paste is squeezed through filter paper and two or three drops of serum placed on the measurement surface of the refractometer. The value measured by the Refractometer is recorded.

Blotter tests—From each sample, 7 ml of pastes are aspirated into a plastic syringe and is carefully transferred into the central circle of a half-hour blotter test card (Bridge and Company, Chancery Lane, London). The test card is placed on top of an upright plastic beaker, and after half an hour the distance (in millimeters) migrated by the serum of the tomato paste is recorded along each of the four axes (North, South, East and West). Two blotter tests are carried out for each sample, and the four values are averaged. The larger the blotter value, the greater the level of syneresis present in the sample.

USDA paste color test—The color of a tomato concentrate is measured after dilution to 8.5 Brix, using the ColorQuest Instrument from Hunter. The a & b values obtained from a UCD/USDA hitched instrument are computed using the following equation.

Paste & Puree=−46.383+1.02411(a)+10.607(b)−0.42198(B)\hat{ }2 Color Score

Juice Color=29.600+0.88354(a)−1.8553(b)

USDA Color Classifications are as follows:

| | |
|---|---|
| Grade A | 45-50 points |
| Grade C | 40-44 points |
| Substandard | 0-39 points |

USDA grading of concentrate is done with equal weight given to color and absence of defects.

It should be noted that in addition to the tomato itself, color may be severely affected by thermal processing.

Serum:pellet ratios—these are determined by placing a weighed amount of each paste into a centrifuge tube, centrifuging at 5,000-10,000×g for 30 minutes, pouring off the serum, and recording the weights of the serum and the pellet. From these values the serum:pellet ratio can be calculated.

Serum viscosity—A Contraves Low Shear 30 Rheometer is used to measure the serum viscosity. A small amount of serum (approx. 2 mls) prepared as for measuring serum:pellet ratios is placed in the cup-and-bob apparatus and a range of shear rates used to determine \acute{η}^{o} (viscosity at zero shear).

Small deformation rheology—A small amount of tomato paste mixture (approximately 3 g) is placed between parallel plates on a Rheometrics RDA2 (5 cm diameter, roughened by attachment of emery paper to plate surfaces to reduce slippage or surface friction phenomena). Frequency sweep measurements are made from 0.5-200 radian per second (rads⁻¹), at 0.5% strain and at 30° C. G′ values are taken from the 10 rads⁻¹ measurement. Time sweep measurements are made at 0.5% strain, 10 rads⁻¹ and 30° C. All samples are sealed with liquid paraffin to avoid desiccation or water exchange.

Dry Weight Estimates—samples of the pastes as delivered and from the dilution series for the concentration dependencies are placed into preweighed 10 ml glass vials. These are then weighed to enable the mass of the wet sample to be calculated. The vials are allowed to dry to constant weight at 60° C. under vacuum (in a benchtop vacuum oven). Dry weights of the vials are measured and used to calculate the % dry wt. of the original samples.

Total serum polymer—17.2076 g of rinrin paste equivalent to 3.132 dry weight and 14.2781 g of Bos 3155 paste equivalent to 3.6980 g dry weight, are washed extensively with MilliQ deionized water and all water washings collected after centrifugation at 2300 rpm on a benchtop centrifuge. The collected washing for each sample are dialyzed with 6 exchanges of MilliQ deionized water using a 14,000 cutoff dialysis membrane. The resultant solution is freeze dried and the polymers weighed and used for further analysis.

Cell wall preparation from juice—Cell wall is prepared after removal of serum with sequential water washes, by washing in absolute ethanol until white. The material is then hydrated with water to a dry weight of ˜5%.

Sugar composition of serum polymers and cell wall—5 mg of hydrated cell wall and 1 mg of serum polymers isolated as above are incubated in a solution of mannitol containing the cell wall degrading enzymes Viscozyme, Celluclast and Novozyme from Novo Nordisk (final concentration of 488 nmols per 250 uL). The mixture is left overnight at 45° C. and freeze dried. Once dry, the samples are hydrolyzed at 87° C. in teflon capped screwtop tubes with dry 2 Molar methanol/HCI prepared fresh. The samples are worked up by neutralizing with silver carbonate and addition of 2 drops of acetic anhydride. The methanol layer is decanted off and evaporated to give the methylglycosides. These are analyzed as the silyl ethers on a Carlo-erba Mega GC using the temperature program 150° C.-200 at 2° C. on a CPSIL 5CB 25M column. Results are calculated after subtraction of an enzyme blank.

Degree of esterification (% galacturonic ester)—Serum polymer isolated as above is redissolved in MilliQ deionized water at a concentration of 1 mg/ml. 15 ml of each solution is then titrated to pH7 and the volume of titrant noted to reach equivalence. 100 units of pectin methyl esterase (from Sigma) are added and the solution autotitrated using a Metrohm 718 Stat Titrino at pH 7 until complete deesterification occurs. The total volume of titrant added is noted and the percent ester calculated as follows:

(ml Total−ml acid/ml Total)*100

Oligosaccharide analysis by Dionex—Samples of serum obtained by washing the pastes with 3 volumes of MilliQ water are run on a Dionex HPLC system with amperometric detection. The solvent system used is a binary system and the gradient used is given in the table below:

| Time | % 100 mm NaOH | % 100 mm Sodium acetate |
|---|---|---|
| 0 | 100 | 0 |
| 30 | 60 | 40 |
| 35 | 0 | 100 |
| 40 | 0 | 100 |
| 45 | 100 | 0 |

The column used is a 50 cm Carbopac PA100. Samples are filtered through a 0.45 um PVDF Whatman filter before injection.

Bostwick: The Bostwick Consistometer is commercially available and comprises a stainless-steel, rectangular trough with two compartments separated by a spring-loaded gate. The sample compartment measures 5 cm.×5 cm.×3.8 cm. The larger of the troughs measures 24 cm. in length, 5 cm. in width and is etched with graduations every 0.5 centimeter. A clean, dry consistometer, maintained at 20 deg. C., is placed on a flat surface and a spirit level placed in the larger trough. Leveling screws are used to adjust the position of the device.

A sample of a diluted and temperature adjusted tomato concentrate is placed in the sample compartment and its surface leveled off with the flat side of a spatula. The gate locking lever is tripped and immediately a timer started. The sample is allowed to flow down the length of the trough, under its own weight for a fixed amount of time (usually 30 seconds). The distance the front edge of the fluid travels is estimated to the nearest 0.1 centimeter.

The United States Department Of Agriculture uses this method in grading tomato concentrates. The tomato concentrate is diluted to 12.0 NTSS as measured by a refractometer on a centrifugate of the sample. An amount of distilled water is added to 100 grams of tomato concentrate in a plastic bag, to achieve the 12.0 NTSS. The sample and water are “stomached” (mixed) to achieve the uniform distribution of the paste in the water. The NTSS of the resulting material is tested again to confirm it to be 12.0 NTSS and if indicated, adjusted to achieve the desired value. Once the sample is diluted its temperature is adjusted to 20 deg. C. and the test performed.

The Bostwick Consistency of a tomato concentrate is the number of centimeters the material flows under its own weight in thirty seconds.

Results

General appearance—Three teaspoons of each paste are placed onto a clean dish and their appearance is noted after 30 minutes ana 1 hr 30 minutes.

30 minutes—The rinrin paste remains unchanged at 30 minutes. It still holds shape and shows no signs of synersis (pooling). However the BOS 3155 control has slumped and spread a little with a ring of syneresed serum projecting around 2 mm from the central mass.

1 hr 30 minutes—The rinrin paste is much the same as at 30 minutes. The BOS 3155 control has spread and the ring of syneresis is projecting approximately 6 mm from the edge of the solid mass.

Bostwick and Blotter Ranges for rin, BOS 3155 and Other Tomatoes (tomatoes with high viscosity). These paste are processed on the benchtop evaporator described in Example 2.

| | Bostwick | Blotter |
|---|---|---|
| U373 | 3.1-4.7 | 4.5-15.25 |
| U370 | 3.4-4.0 | 10.0-16.75 |
| Asgrow 5210 | 3.5-5.4 | 11.0-18.25 |
| Antisense PG | 3.7-5.3 | 5.6-17.5 |
| BOS3155 | 4.5-6.1 | 13-22.5 |
| Homoz RIN | 0-2.0 | <2.5 |

The USDA paste color scores are 47.98 for the rinrin paste and 47.87-50.19 (ave. 49.33) for the Bos 3155 paste.

The samples as received in the can have the following characters:—

| Sample | % Dry Weight | °Brix |
|---|---|---|
| RIN | 18.2% | 16.56 |
| BOS 3155 | 25.9% | 24.76 |

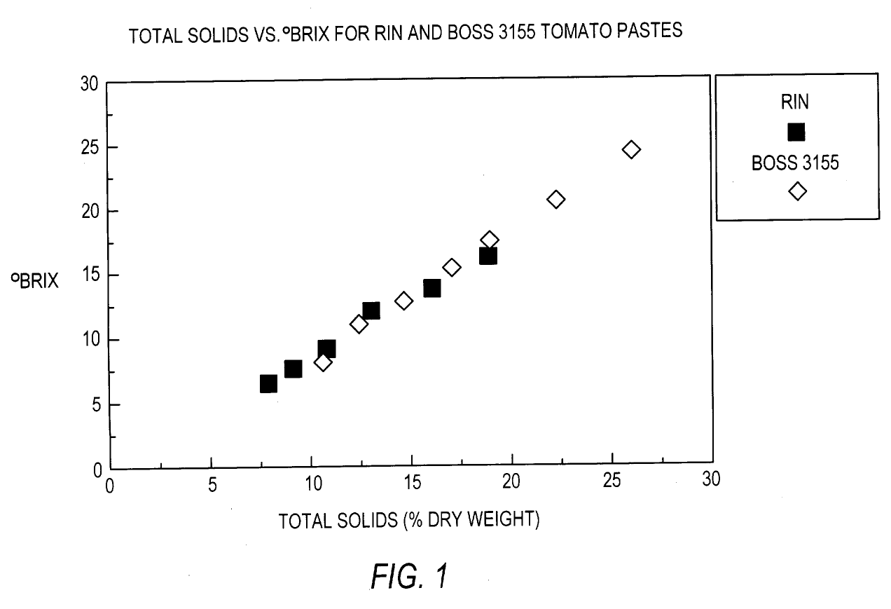

Ratio of soluble to insoluble solids—FIG. 1 shows a plot of the dry weight values vs. their respective °Brix for the samples used in the concentration dependence. As can be seen both the RIN and BOS 3155 pastes have the same slope and the same origin indicating that the ratio of insoluble to soluble solids are the same. With this information in mind it is possible to run the serum pellet ratios balanced for both solids and °Brix in one experimental set.

Concentration Dependencies—The concentration dependence behaviors of G′ (10 rads/s) for RIN and BOS 3155 pastes are given in FIG. 2. RIN appears to have a lower effective C₀ at 7.5% dry wt than BOS at 10% dry wt. The form of the concentration dependencies also shows that RIN solids are capable of generating greater structure on a weight for weight basis than the BOS 3155 control. Because the °Brix to dry wt ratios are the same for the two pastes, plotting °Brix against G′ gives a very similar concentration behavior, as seen in FIG. 3.

Serum/pellet ratios at 12°Brix:—

The results for serum/pellet ratios are as follows:

| Replicate | Serum (g) | Pellet (g) | s/p ratio |
|---|---|---|---|
| RIN | | | |
| 1 | 13.16 | 9.06 | 1.45 |
| 2 | 14.79 | 9.7 | 1.52 |
| 3 | 13.45 | 9.33 | 1.44 |
| BOS 3155 | | | |
| 1 | 15.5 | 8.21 | 1.88 |
| 2 | 14.88 | 7.54 | 1.97 |
| 3 | 15.52 | 8.02 | 1.93 |

Averaged values - RIN = 1.47
BOS 3155 = 1.93
Blotters - Run on 12° Brix paste

| Rep. | Time | North | South | East | West | Avg. |
|---|---|---|---|---|---|---|
| RIN Paste | | | | | | |
| 1 | 10 min | 0 | 0 | 0 | 0 | 0 |
| | 20 min | 2 | 1 | 1 | 1 | 1.3 |
| | 30 min | 3 | 2 | 2 | 1 | 2 |
| 2 | 10 min | 0 | 0 | 0 | 0 | 0 |
| | 20 min | 1 | 1 | 0 | 1 | 0.75 |
| | 30 min | 2 | 2 | 1 | 1 | 1.5 |
| BOS 3155 paste | | | | | | |
| 1 | 10 min | 3 | 4 | 5 | 4 | 3 |
| | 20 min | 10 | 8 | 7 | 8 | 8.25 |
| | 30 min | 11 | 12 | 11 | 10 | 11 |
| 2 | 10 min | 4 | 4 | 4 | 4 | 4 |
| | 20 min | 8 | 8 | 7 | 7 | 7.5 |
| | 30 min | 10 | 10 | 9 | 9 | 9.5 |

Serum results

| | | Polymer weight | Percentage |
|---|---|---|---|
| | η₀ values at 20° C. | (mg/g dry weight | galacturonic acid |
| | (mPas) | paste) | esterified |
| RIN | 38.25 | 64.6 | 73 |
| BOS 3155 | 4.81 | 64.2 | 40 |

Sugar analysis results

| | | | 3155 | 3155 cell |
|---|---|---|---|---|
| Sugar | Rin serum | Rin cell wall | serum | wall |
| Ararabinose | 3 | 3 | 4 | 2 |
| rhamnose | 4 | 3 | 8 | 1 |
| xylose | 1 | 11 | 1 | 10 |
| mannose | 3 | 6 | 4 | 7 |
| Galactose | 6 | 6 | 4 | 5 |
| Galacturonic | 80 | 23 | 76 | 9 |
| Acid | | | | |
| Glucose | 3 | 49 | 2 | 65 |

Dionex Results

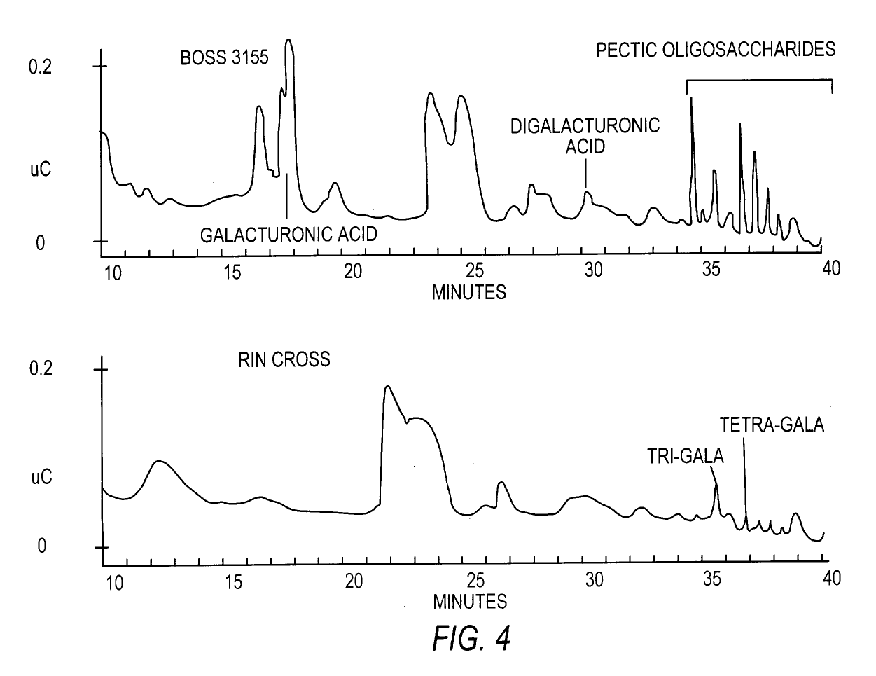

These results, shown graphically in FIG. 4, are unquantified as no standards are available at the time of analysis. However, qualitatively there are differences in the amounts of pectic oligomers produced between the two paste serums. The RIN cross has qualitatively fewer pectic oligomers caused by pectin breakdown either during processing or through natural fruit ripening.

Overall, the data establish that pastes according to the invention have quite good viscosity together with good color.

### EXAMPLE 3

### Prophetic

A spaghetti sauce is prepared in accordance with the invention using a puree made solely from rinrin tomatoes. A standard, conventional spaghetti sauce made from tomatoes other than rinrin tomatoes is also prepared. The sauces are prepared by mixing together the ingredients, heating and stirring.

SPAGHETTI SAUCE FORMULAS

| | STANDARD | RIN |
|---|---|---|
| | PUREE | PUREE |
| INGREDIENT | PERCENT | PERCENT |
| WATER | 33.300 | 65.300 |
| TOMATO PUREE @ 15.5 BRIX | 64.000 | 32.000 |
| SOYBEAN SALAD OIL | 1.000 | 1.000 |
| SALT, ROCK | 1.000 | 1.000 |
| ONIONS | 0.500 | 0.500 |
| SPICES | 0.200 | 0.200 |

The sauce according to the invention made from rin paste has excellent quality, in particular, improved viscosity and syneresis compared to the conventional sauce. Moreover, the sauce of the invention includes substantially more large pectin chains. In addition, a secondary benefit is the fact that less puree needs to be used in the sauce of the invention as compared to the standard sauce.

Tomatoes in accordance with the invention fall within the genus Lycopersicon and preferably, though not necessarily, within the species Lycopersicon esculentum.

Preferably the pastes of the invention are made from essentially the same tomato plants. That is, the pastes of the invention preferably achieve the desired attributes of color and viscosity without resort to substantial amounts of tomato fruits which are not either a) homozygous for the rin and/or nor and/or alc genes or b) heterozygous for both rin and/or nor and/or alc genes. Preferably the paste is made from at least 90%, more preferably at least 95% of tomatoes and most preferably at least 99 wt. % of tomatoes which are either a) homozygous for the ripening inhibiting or b) heterozygous for both rin and/or nor and/or alc genes. It is especially preferred that the paste comprises at least 90%, more preferably at least 95% of tomatoes and most preferably at least 99 wt. % of tomatoes which are i) either homozygous or heterozygous, preferably homozygous, in at least one non-native color enhancing gene and ii) either a) homozygous for the rin and/or nor and/or alc genes and/or b) heterozygous for both rin and/or nor and/or alc genes.

### EXAMPLES 4-7

In the experiments below, the following methods were followed.

Brix

A digital refractometer (Bellingham Stanley RFM 342 digital refractometer) thermostatically controlled at 20° C. was used. The refractometer was calibrated with a range of 1-30% w/w sucrose in de-ionized water as standard solutions. Enough tomato product was weighed into centrifuge tubes to provide a 1-2 ml liquid layer after centrifugation and centrifuged in a high speed centrifuge at 20° C., using a Beckman Optima TLX ultracentrifuge (TLA100.4 8-position fixed angle rotor) having the following gradient: 5,000/2 min., 20,000/2 min., 75,000/4 min., 100,000/10 min., 50,000/1 min., end).at 95,000 RPM +/−5,000 RPM for 5 minutes to separate liquid from solid. The centrifugate liquid was placed in a small vial and mixed gently. The liquid was placed on the optic of a thermostatted refractometer, the lid closed and measured after the sample had sat for 30 seconds to reach the required temperature. The average of triplicate readings was calculated.

Bostwick

Bostwick measurement was performed on a 25 cm Bostwick leveled in two directions. Paste was diluted to 12° Brix and warmed or cooled to 20° C. Sample was placed in the Bostwick to the top of the sample chamber and the trap door opened. Degree of flow was determined after 30 seconds.

Samples were each tested in duplicate.

Insoluble Solids

Tomato paste was sourced from around the world including Unilever factories in Chile (Malloa), Calif. (Stockton/Merced), India and Australia (Tatura) and external sources (Conesa, ARC, Copais) These were used to construct a calibration line for tomato paste at 12 Brix.

A 1-1.5 g sample of juice was weighed out to 4 decimal places between 4 pre-weighed filters (Whatman GFA 5.5 cm diameter). This was then placed on a Buchner vacuum filtration system and washed with 6 liters of de-ionized water. The filters were then dried in a vacuum oven at 70° C. for 1.5 hours and then cooled in a dessicator to room temperature. The filters were then re-weighed and insoluble solids calculated as the final weight minus initial filter weight, divided by the initial juice weight minus filter weight. Determination was carried out in triplicate.

% insolubles=(weight of dried sample+filter)−filter/sample weight*100

Also, the dilution factor from paste to 5°Brix juice as above was taken into account by separate multiplying.

### EXAMPLE 4

### Breeding and Selection

As starting material a cross between a homozygous ripening-inhibited mutant (thought to be alc) and a homozygous old gold crimson (ogc) mutant was obtained from Ohio State University, USA (accession number 96-9422-400). This population of F1 heterozygous alc/ogc was then selfed, and single plants selected that had the phenotypical characteristics of both fruit ripening-inhibition (homozygous alc) and golden flower color (homozygous ogc). Seed from selected plants was then back-crossed with in-house breeding lines to produce stable double homozygous plants, for evaluation of fruit and processed tomato product characteristics.

### EXAMPLE 5

### Bostwick vs. Insoluble Solids: 22 Conventional Pastes (Control) and According to Invention

Of 22 hot and cold break tomato pastes from factories or commercially available the percentage of insoluble solids was measured, and the Bostwick value was determined (all at 12°Brix). The Bostwick values (averages of various measurements per paste) were then plotted against percentage of insoluble solids.

The hot break pastes were either commercially available products, or were prepared in own factories using the following process: the tomatoes are crushed with a minimum of air inclusion and quickly heated to greater than 85° C. typically through contact with a steam coil. The juice is then extracted and evaporated typically by a 2 or 3 stage process to between 24° and 31°Brix. For measuring, the samples were diluted to 12°Brix.

The cold break pastes were commercially available products, and are typically prepared by crushing the tomatoes at temperatures of less than 85° C. with a minimum of air inclusion. The juice is then extracted and evaporated by typically a 2 or 3 stage process to between 24 and 31°Brix. For measuring, the samples were diluted to 12°Brix.

The percentage insoluble solids was calculated as described earlier. The Bostwick value was determined using the method as described earlier. The results of these measurements are in table 1.

TABLE 1
insoluble solids and Bostwick of 22 commercially available pastes

| Insoluble solids | Bostwick |
|---|---|
| 1.756 | 7.6 |
| 2.0545 | 6.75 |
| 2.062 | 6.4 |
| 2.0845 | 6.6 |
| 2.162 | 6.3 |
| 2.217 | 5.8 |
| 2.353 | 5.8 |
| 2.368 | 5.5 |
| 2.413 | 5.5 |
| 2.568 ⁽¹⁾ | 5.1 |
| 2.6515 | 5 |
| 2.674 | 4.9 |
| 2.678 | 4.2 |
| 2.7415 | 4.75 |
| 2.95 ⁽²⁾ | 4.5 |
| 2.974 | 4 |
| 2.98 ⁽³⁾ | 4.3 |
| 3.07 | 4.1 |
| 3.139 | 3.25 |
| 3.38 | 3.2 |
| 3.38 | 3.25 |
| 3.6 ⁽⁴⁾ | 2.7 |

Source of some of the pastes:
⁽¹⁾ Chilean Malloa
⁽²⁾ Unilever Van den Bergh's
⁽³⁾ CONESA
⁽⁴⁾ COPAIS

Two trial harvests of alc-ogc tomatoes (according to the invention) were processed and Bostwick/insolubles measured in the same manner, with results:

| Insoluble solids | Bostwick |
|---|---|
| 3.3 | 0.9 |
| 3.6 | 0.5 |

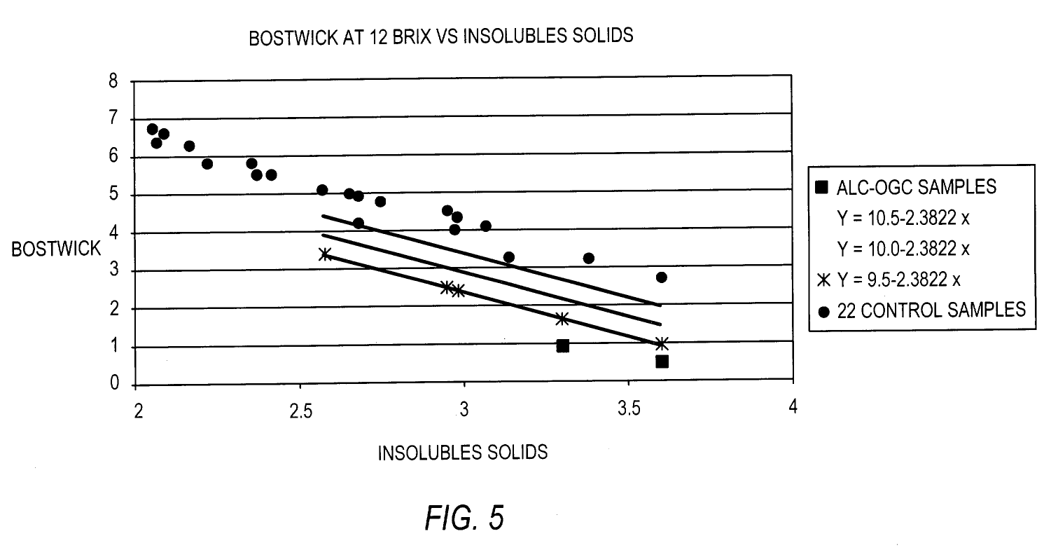

The results are set out graphically together with the results of table 1 in FIG. 5. FIG. 5 also gives lines for the equations:

(Bostwick value )=10.5-2.3822×(percentage of insoluble solids) (1)

(Bostwick value )=10.0-2.3822×(percentage of insoluble solids) (2)

(Bostwick value )=9.5-2.3822×(percentage of insoluble solids) (3)

(4)

As can be seen, all conventional pastes tested have a Bostwick value larger than equation (1) above would give, at the insoluble solids interval of 2.5-3.6%.

### EXAMPLE 6

### Exogalactanase Activity

Exogalactanase activity of four types of tomatoes were measured at three stages of maturity: in the green stage (i.e. well before breaker point), 5-6 days post breaker, and 12-13 days post breaker. The four types tomatoes were: the tomato according to example 4, which is thought to be homozygous for alc and homozygous for ogc, Bos 3155 (as commercially available) U338 (internal breeding line with conventional ripening and color) and homozygous ogc (internal breeding line with conventional ripening).

The exogalactanase activity was expressed as nmoles galactose per gram fresh weight (fwt) per hour that could be converted. The galactose conversion was measured using the following protocol.

Preparation of Extracts

Samples of tomato pericarp were taken from the frozen storage and placed in a 50 ml Falcon tube containing PVPP (1% w/v buffer). 1:1.5 (w:v) of 0.2M NaPhosphate buffer pH7.5 was then added. This was left for 60 mins at 4° C. for the fruit to defrost slightly to allow a more uniform homogenization. A Polytron SEV was used for 1-2 mins to homogenize the fruit. The extract was stirred for 20 mins, left to stand for 20 mins then centrifuged at 38,700×g for 20 mins (all performed at 4° C.). The supernatant was divided into 1 ml aliquots for the subsequent assays and frozen at −20° C.

Exogalactanase Assay

Exogalactanase activity was measured by a linked assay consisting of two steps. (1) Galactan was prepared as described [Methods in Carbohydrate Chemistry Volume 5 (pp 132-134] and incubated with extract in the presence of buffer. (2) D-galactose released in (1) was quantified by incubating with NAD and β-D-galactose dehydrogenase as described [Kurz and Wallenfels, 1974. Methods of enzymic analysis, 1279-1282. ed. Verlag Chemie, Weinheim].

1. The following components were mixed and incubated overnight at 30° C. (in duplicate):

| | |
|---|---|
| Test: | 30 μl 10 mg/ml Lupin Galactan |
| | 15 μl 1M Na Acetate, pH 5.0 |
| | 30 μl extract |
| Control: | 30 μl H₂O |
| | 15 μl 1M Na Acetate, pH 5.0 |
| | 30 μl extract |
| Substrate Control: | 30 μl 10 mg/ml Lupin Galactan |
| | 15 μl 1M Na Acetete, pH 5.0 |
| | 30 μl H₂O |

The reaction was stopped by incubating in a boiling water bath for 2 mins.

2. To 64 μl of each incubated sample (above step 1) the following were added;

64 μl Galactose Dehydrogenase [2.5 U/ml]

905 μl 0.1M Tris/HCl pH8.6

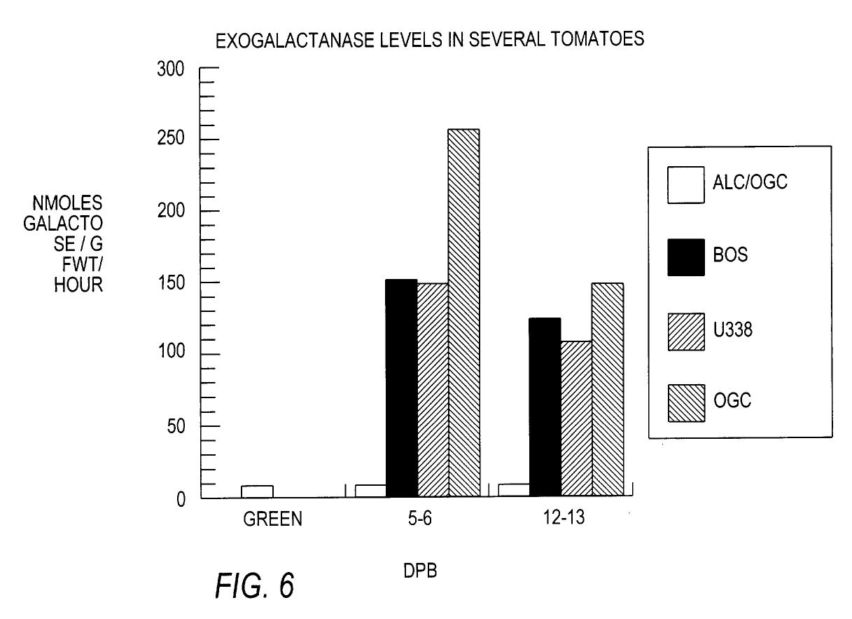

O.D. readings were taken at 340 nm, following which 32 μl 12.5 mg/ml NAD was added. This was incubated at room temperature for 1 hour and a further reading at 340 nm was recorded (it was assumed that for each mole of galactose released, one mole of NADH is formed). Test ΔOD₃₄₀ (minus control and substrate control ΔODs) was converted to nmol gal/g fwt/hr using a galactose standard curve. The results are set out in FIG. 6.

### EXAMPLE 7

### Polygalacturonase Activity

Polygalacturonase activity of four types of tomato was measured at three stages of maturity: 5-6 days post breaker, and 12-13 days post breaker and 19-20 days post breaker. The four types of tomatoes as in example 6 were analyzed.

Polygalacturonase activity was measured using the PAHBAH method [Lever, M (1972) A new reaction for calorimetric determination of carbohydrates. Anal. Biochem. 47:273-279].

Materials: Solutions

Assay buffer stock: 50 mM sodium acetate buffer, pH 4.0 with) 0.2M NaCl. Substrates Sigma polygalacturonic acid (PGA), 0.4% stock in water (fresh) Standard: Sigma D-galacturonic acid, 50 mg/100 ml stock (fresh) Enzyme extract: Tomato extracts were prepared as described in Example 6 except that 2.5 volumes of buffer were used (in order to reduce the level of endogenous reducing sugars).

Megazyme fungal polygalacturonase (ammonium sulphate suspension) was used as a positive control. Enzyme was diluted 1 in 1,000 in assay buffer and stored at −20° C. Prior to use the enzyme was diluted 1 in 25 in assay buffer stock (giving 1 in 25,000 final dilution) and 10-200 ul used per assay.

PAHBAH stock solution A: Slurry 10 g para-hydroxybenzoic acid hydrazide (Sigma) in 60 ml H₂O. Add 10 ml conc. HCl, mix and make up to 200 ml with water (pale yellow solution, may be stored in fridge for several weeks).

PAHBAH stock solution B: Dissolve 29.4 g trisodium citrate (0.05M) in 500 ml water. Add 2.2 g anhydrous (2.9 g dihydrate) calcium chloride (0.01M), mix well. Add 40 g NaOH (0.5M), dissolve and make up to 2 liters with water (colorless solution, may be stored in fridge for several weeks).

Materials: Equipment

Boiling water bath or dry heating block.

Temperature controlled water bath (40° C. ) or dry heating block.

UV spectrophotometer and cuvettes.

Teflon capped tubes (5 ml).

Method

1. Aliquot 0.25 ml of 0.4% PGA into teflon capped tubes.

2. Add up to 0.25 ml of enzyme extract, diluted if required. Final concentrations are then 0.2% PGA, in 25 mM Na Ac buffer pH 4.0 with 0.1M NaCl. Include buffer only negative control, boiled diluted enzyme negative control and Megazyme PG positive control at this stage.

3. Incubate at 40° C. for 1 hour.

4. Make up PAHBAH C reagent—add 1 part of PAHBAH A to 9 parts of PAHBAH B and mix well. Make fresh just before use and keep on ice during use.

5. After 1 hour incubation time, add 5 mL of PAHBAH C to each assay/standard sample and immediately incubate at 100° C. for 6 minutes, ensuring that teflon cap is firmly screwed in place. (If doing t=0 controls, aliquot 0.25 ml of PGA into tube, add 5 ml PAHBAH C, then 0.25 ml of appropriate enzyme dilution).

6. Cool in running water.

7. Make up standard curve with galaturonic acid as below, setting up duplicate samples:

| Gal A Stock | | |
|---|---|---|
| (50 mg/100 ml) per ml | WATER per ml | Nmoles Gal A/0.5 ml |
| 0.5 | 0 | 1175 |
| 0.4 | 0.1 | 940 |
| 0.3 | 0.2 | 705 |
| 0.2 | 0.3 | 470 |
| 0.1 | 0.4 | 235 |
| 0.05 | 0.45 | 117 |
| 0.025 | 0.475 | 59 |
| 0 | 0.5 | 0 |

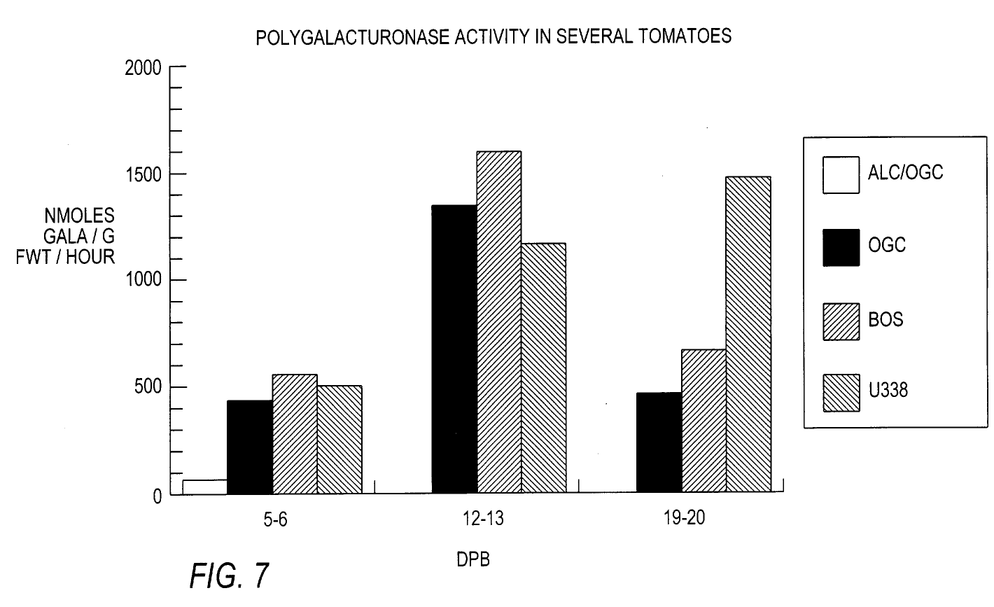

The results are set out in FIG. 7

All percentages herein are by weight unless stated otherwise or otherwise required by context.

It should be understood, of course, the specific forms of the invention herein illustrated and described are intended to be representative only as certain changes may be made therein without departing from the clear teachings of the disclosure. For instance, other ways of improving the color of tomatoes which are homozygous in rin and/or nor and/or alc or which are heterozygous in rin and/or nor and/or alc may occur to those skilled in the art. These may, for example, include breeding of the rin or nor or tomatoes with certain tomatoes having desirable color attributes.

Reference should be made to the following appended claims in determining the full scope of the invention.

1. Tomato paste having an increased consistency such that when measured at an insoluble solids interval of 2.5-3.6% at 12°Brix:
(Bostwick value )<10.5−2.3822×(percentage of insoluble solids).

2. Tomato paste according to claim 1, such that when measured at insoluble solids interval of 2.5-3.6% at 12°Brix:
(Bostwick value)<10.0−2.3822×(percentage of insoluble solids).

3. Tomato paste according to claim 2, such that when measured at an insoluble solids interval of 2.5-3.6% at 12°Brix:
(Bostwick value)<9.5−2.3822×(percentage of insoluble solids).

4. Tomato paste according to claim 1-3, wherein the paste is obtained by a hot break process, and optionally followed by concentration.

5. Tomato paste according to claim 1-4, having a USDA color score at 8.5°Brix of 35-60.

6. Processed tomato product, wherein at least 10% (pref. 20%, more pref. 50%) tomatoes which are homozygous for rin, homozygous for nor, homozygous for Nr, homozygous for alc, heterozygous for combinations of two of the rin, nor, Nr or alc genes, or combinations thereof.

7. Product according to claim 6 comprising tomatoes which are homozygous for at least two genes of rin, nor, Nr, or alc.

8. Product according to claim 6-7 having USDA color scores at 8.5 Brix of at least 35.

9. Product according to claim 8 having USDA color scores of 42 or greater.

10. Product according to claim 8-9, having USDA color scores of less than 60.

11. Product according to claim 6-10 wherein said tomatoes further comprise at least one color-enhancing gene.

12. Product according to claim 11 wherein said color enhancing genes are selected from the group consisting of old god crimson (ogc), high pigment (hp), dark green (dg), Intense pigment (Ip), as well as color enhancing transgenic genes

13. Product according to claim 6-12, wherein the processed tomato product is in the form of tomato pastes, tomato sauces, tomato juices, tomato concentrates, tomato passatas, salsa, barbecue sauce, pizza sauce, spaghetti sauce, tomato fritto, ketchup (catsup), soup or other form.

14. Process for preparing 3 tomato product, the product having a USDA color score of 35-60 and wherein at least 10% (pref. 20%, more pref. 50%) of the tomatoes to be processed have a level of polygalacturonase of less than 200 (preferably less than 100, more pref. less than 50) μmoles GalA/ml/hour, and wherein said tomatoes to be processed have a level of exogalactanase of less than 70 (preferably less than 35) nmoles galactose/g fwt/hour.

15. Process according to claim 14, wherein at least 10% (pref. 20%, more pref. 50%) of the tomatoes to be processed are homozygous for rin, homozygous for nor, homozygous for Nr, homozygous for alc, heterozygous for combinations of two of the rin, nor, Nr or alc genes, or combinations thereof.

16. Process according to claim 14-15, wherein other ripening-inhibiting genes than alc, rin, nor, Nr, are present in the tomato in such a genotypic form that they inhibit ripening.

17. Process according to claim 14-16, wherein said tomatoes further comprise at least one color enhancing gene.

18. Process according to claim 17, wherein said color enhancing genes are selected from the group consisting of old gold crimson (ogc), high pigment (hp), dark green (dg), intense pigment (Ip), as well as color enhancing transgenic genes.

19. Process according to claim 14-18, wherein the process comprises the steps of:
heating tomatoes to a temperature of 60-120° C.
comminuting or dicing said tomatoes in any given order.

20. A tomato paste comprising tomatoes having homozygous mutant rin genes, homozygous mutant nor genes or tomatoes heterozygous in both rin and nor genes.

21. The tomato paste according to claim 20 which is homozygous in both mutant rin and mutant nor genes.

22. The paste according to claim 20 having USDA paste color scores at 8.5 Brix of from 35-50.

23. The paste according to claim 22 having USDA paste color scores of 42 or greater.

24. The paste according to claim 20 comprising at least 50% by weight tomatoes having homozygous mutant rin genes, homozygous mutant nor genes or tomatoes heterozygous in both rin and nor genes.

25. The tomato paste according to claim 20 wherein said tomatoes further comprise a color enhancing gene.

26. The paste according to claim 25 wherein said color enhancing genes are selected from the group consisting of old gold crimson, high pigment, dark green, intense pigment and color enhancing transgenic genes.

27. The paste according to claim 26 wherein said paste comprises at least 50 wt. % of said tomatoes.

28. The paste of claim 24 wherein at least 50% of the tomatoes used to make the paste have homozygous mutant rin genes, homozygous mutant nor genes or are heterozygous in both rin and nor genes.

29. The paste of claim 27 wherein at least 50% of the tomatoes used to make the paste have homozygous mutant rin genes, homozygous mutant nor genes or are heterozygous in both rin and nor genes.

30. A sauce comprising tomatoes having homozygous mutant rin genes, homozygous mutant nor genes or tomatoes heterozygous in both rin and nor genes.

31. The sauce according to claim 30 having 12 to 25 Brix and 4-13 cm Bostwick.

32. The sauce according to claim 31 comprising from 0.5 to 2 wt. % salt and a pH of from 4.0 to 4.4.

33. The sauce according to claim 32 wherein the salt level is from 1 to 2 wt. %.

34. The sauce according to claim 30 which is selected from the group consisting of red spaghetti sauce, other red pasta sauces, pesto sauce, salsa, tomato puree, pizza sauce, tomato sauce, BBQ sauce, catsup and soup.

35. The sauce according to claim 34 wherein said sauce is a red spaghetti sauce.

36. A tomato paste comprising tomatoes having homozygous ripening inhibiting genes.

37. A tomato paste comprising (i) tomatoes having homozygous ripening inhibiting genes or (ii) tomatoes heterozygous in at least two ripening inhibiting genes.
